(19) United States
(12) Patent Application Publication
(10) Pub. No.: US 2024/0349393 A1
(43) Pub. Date: Oct. 17, 2024

(54) DYNAMIC ADJUSTMENT OF DISCONTINUOUS RECEPTION OPERATION FOR DOWNLINK VIDEO TRAFFIC

(71) Applicant: Nokia Technologies Oy, Espoo (FI)

(72) Inventors: Muhammad TAYYAB, Oulu (FI); Ahlem KHLASS, Massy (FR); Rapeepat RATASUK, Naperville, IL (US)

(21) Appl. No.: 18/685,705

(22) PCT Filed: Oct. 19, 2022
(86) PCT No.: PCT/EP2022/079123

§ 371 Date: Feb. 22, 2024

Related U.S. Application Data
(60) Provisional application No. 63/276,942, filed on Nov. 8, 2021.

(51) Int. Cl. H04W 76/28; H04W 52/02

(52) U.S. Cl. CPC H04W 76/28; H04W 52/0216

(57) ABSTRACT

In some example embodiments, there may be provided a method that includes receiving, by a user equipment, an indication from a network to adjust a discontinuous reception operation; determining, by the user equipment, an adjustment to the discontinuous reception operation, wherein the adjustment is based at least on an arrival rate of traffic received by the user equipment; and applying, by the user equipment, the adjusted discontinuous reception operation to one or more frames carrying the traffic. Related systems, methods, and articles of manufacture are also disclosed.

### FIELD

The subject matter described herein relates to wireless communications.

### BACKGROUND

A purpose of the Discontinuous Reception (DRX) mode is to provide efficient user equipment (UE) power savings, which may for example optimize the UE's battery lifetime. By applying a DRX configuration (which may be received from the network), the UE may be allowed to enter into a sleep mode (e.g., with the UE's radio frequency (RF) module turned off) after a certain data inactivity and to wake up periodically for an eventual data reception or for initiating data transmission. For example, the DRX operation may be applied to a user equipment (UE) in a radio resource control (RRC)-connected state (e.g., using a connected mode DRX (CDRX) configuration which is provided by the network), and may be applied to a UE in an RRC-idle (or inactive) state (e.g., through a paging configuration provided by the network).

### SUMMARY

In some example embodiments, there may be provided a method that includes receiving, by a user equipment, an indication from a network to adjust a discontinuous reception operation; determining, by the user equipment, an adjustment to the discontinuous reception operation, wherein the adjustment is based at least on an arrival rate of traffic received by the user equipment; and applying, by the user equipment, the adjusted discontinuous reception operation to one or more frames carrying the traffic.

In some variations, one or more of the features disclosed herein including the following features can optionally be included in any feasible combination. The adjusted discontinuous reception operation may include adjusting at least one cycle length applied to the one or more frames and/or adjusting at least one on-duration time applied to the one or more frames. The discontinuous reception operation may include a connected mode discontinuous reception operation. The receiving may further include receiving a minimum on-duration time for the discontinuous reception operation. The determining of the adjustment may further include selecting a cycle length from a set of possible cycle lengths for the discontinuous reception operation, wherein the cycle length is selected based at least on the arrival rate of the traffic. The cycle length selected may be a largest value in the set that is less than or equal to the arrival rate of the traffic. The determining of the adjustment may further include determining, based at least on a rounding error of a given frame and a minimum on-duration time, an applied on-duration time to apply to the one or more frames carrying the traffic, wherein the adjusted discontinuous reception operation comprises the applied on-duration time and the selected cycle length. The determining of the adjustment may further include checking to confirm a rounding error of a given frame does not equal or exceed a threshold amount; in response to the rounding error being equal to or exceeding the threshold amount, selecting another, larger cycle length from the set of possible cycle lengths, and wherein the adjusted discontinuous reception operation, for the given frame, comprises applying the larger cycle length. The threshold amount may correspond to a difference between the selected cycle length and a next, larger cycle length in the set of possible cycle lengths. The user equipment may send a response to the network, wherein the response indicates application by the user equipment of the adjusted discontinuous reception operation to the one or more frames carrying the traffic. The traffic may include traffic with a non-integer arrival time, and/or the traffic may include video traffic.

In some example embodiments, there may be provided a method that includes determining, by a network node, whether to trigger an adjustment to a discontinuous reception operation for one or more frames of traffic on a downlink to a user equipment; sending, by the network node, an indication to adjust the discontinuous reception operation for the one or more frames of the traffic on the downlink to the user equipment, the adjustment based at least on a frame rate of the one or more frames of the traffic; and receiving, by the network node, a response from the user equipment, wherein the response indicates the adjustment by the user equipment of the discontinuous reception operation for the one or more frames of the traffic on the downlink to the user equipment.

In some variations, one or more of the features disclosed herein including the following features can optionally be included in any feasible combination. The adjustment may include adjusting at least one cycle length applied to the one or more frames and/or at least one on-duration time applied to the one or more frames. The determining to trigger the adjustment may be based at least on a frame inter-arrival time of the one or more frames of the traffic not corresponding to an integer value of at least one of a set of possible cycle lengths. The discontinuous reception operation may include a connected discontinuous reception operation, and/or wherein the network node may include a gNB base station and/or a distributed unit of a gNB. The sending may include sending a minimum on-duration time for the discontinuous reception operation. The network node may adapt transmission of the traffic on the downlink, the adapting based at least on the adjustment of the discontinuous reception operation. The adapting may include selecting a cycle length from a set of possible cycle lengths for the discontinuous reception operation, wherein the cycle length is selected based at least on the frame rate of the traffic. The cycle length selected may be a largest value in a set of possible cycle lengths that is less than or equal to a frame inter-arrival time of the traffic. The adapting may further include determining, based at least on a rounding error of a given frame and a minimum on-duration time, an applied on-duration time for the adjusted discontinuous reception operation, wherein the adjusted discontinuous reception operation comprises the applied on-duration time and the selected cycle length. The adapting may further include checking to confirm a rounding error of a given frame does not equal or exceed a threshold amount; and in response to the rounding error being equal to or exceeding the threshold amount, selecting another, larger cycle length from among the set of possible cycle length values, and wherein the adjusted discontinuous reception operation, for the given frame, comprises applying the larger cycle length. The traffic may include traffic with a non-integer arrival time, and/or the traffic may include video traffic.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a connected DRX configuration (CDRX) including a DRX cycle length including on-duration, in accordance with some example embodiments;

FIG. 2A depicts a DRX cycle with the corresponding arrivals of video frames, in accordance with some example embodiments;

FIG. 2B depicts an example of a process for adapting the CDRX configuration, in accordance with some example embodiments;

FIG. 3A depicts an example of a dynamically adjusted CDRX configuration, in accordance with some example embodiments;

FIG. 3B depicts another example of a dynamically adjusted CDRX configuration, in accordance with some example embodiments;

FIG. 4A depicts an example of a process for dynamically adjusted CDRX configuration from the perspective of user equipment, in accordance with some example embodiments;

FIG. 4B depicts an example of a process for dynamically adjusted CDRX configuration from the perspective of the network, in accordance with some example embodiments;

FIG. 5A depicts an example of a process for dynamically adjusted CDRX between a user equipment and the network, in accordance with some example embodiments;

FIG. 5B depicts an example of a process for adjusting the DRX configuration from the perspective of the UE, in accordance with some example embodiments;

FIG. 5C depicts an example of a process for adjusting the DRX configuration from the perspective of the network, in accordance with some example embodiments;

FIG. 6 depicts an example of a network node, in accordance with some example embodiments; and

FIG. 7 depicts an example of an apparatus, in accordance with some example embodiments.

Like labels are used to refer to same or similar items in the drawings.

### DETAILED DESCRIPTION

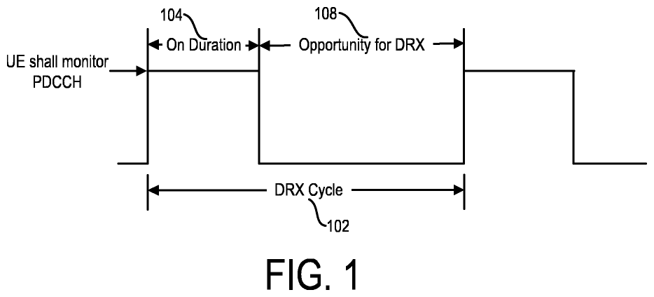

FIG. 1 depicts an example of a connected mode DRX configuration (CDRX), which may define a DRX cycle length 102 (e.g., a short cycle, a long cycle, and/or the like) and an on-duration 104. During the on-duration 104 portion, the UE may perform for example channel monitoring of a downlink (DL) channel (e.g., a channel such as the physical downlink control channel (PDCCH)). During portion 108 of the DRX cycle, there is an opportunity for the UE to enter into a sleep state or other type of power savings mode for the UE. For example, the network, such as a gNB, may provide a DRX configuration (which may define at least the DRX cycle length 102 and/or the on duration 104) to the UE through a dedicated message, such as an RRC reconfiguration message (during a handover, for example) or in System Information Block Type 2 (SIB2) message broadcasted by a gNB (during an initial attach, for example).

The DRX configuration (which is also referred to as the “DRX operation”) may be adjusted to the traffic profile, which may provide power savings at the UE. For example, a long DRX cycle may be considered if there is no data activity, and short, repeated DRX cycles may be used in situations where there is periodic downlink data arrival. The DRX configuration may, as noted, be sent to the UE in a message or other data object, such as in a drx-Config IE structure (an example of which is specified by 3GPP TS 38.331). Table 1 depicts an example of the elements of the drx-Config IE structure.

TABLE 1
drx-Config IE

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, ms40, ms50, ms60, |
| | ms80, ms100, ms200, ms300, ms400, ms500, ms600, ms800, ms1000, ms1200, |
| | ms1600, spare8, spare7, spare6, spare5, spare4, spare3, spare2, spare1 } |
| | }, |
| drx-Inactivity Timer | ENUMERATED { |
| | ms0, ms1, ms2, ms3, ms4, ms5, ms6, ms8, ms10, ms20, ms30, ms40, ms50, ms60, |

ms80,

| | |
|---|---|
| | ms100, ms200, ms300, ms500, ms750, ms1280, ms1920, ms2560, spare9, spare8, |
| | spare7, spare6, spare5, spare4, spare3, spare2, spare1}, |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, sl64, sl80, sl96, sl112, sl128, |
| | sl160, sl320, spare15, spare14, spare13, spare12, spare11, spare 10, spare9, |
| | spare8, spare7, spare6, spare5, spare4, spare3, spare2, spare1 }, |
| drx-RetransmissionTimerUL | ENUMERATED { |
| | sl0, sl1, sl2, sl4, sl6, sl8, sl16, sl24, sl33, sl40, sl64, sl80, sl96, sl112, sl128, |
| | sl160, sl320, spare15, spare14, spare13, spare12, spare11, spare10, spare9, |
| | spare8, spare7, spare6, spare5, spare4, spare3, spare2, spare1 }, |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, ms20, ms30, ms32, |
| | ms35, ms40, ms64, ms80, ms128, ms160, ms256, ms320, ms512, ms640, spare9, |
| | spare8, spare7, spare6, spare5, spare4, spare3, spare2, spare1 }, |
| drx-ShortCycleTimer | INTEGER (1..16) |
| } | OPTIONAL, -- Need R |
| drx-SlotOffset | INTEGER (0..31) |

}

In the case of video traffic for example, it can be periodic as video frames can be generated continuously with a fixed period. For example, typical frame rates of video traffic are 30 frames per second or 60 frames per second (although other frame rates can be realized as well for video). These frame rates may correspond to non-integer inter-frame intervals. For example, at a video frame rate of 60 frames per second, the frame inter-arrival rate is 16.66 milliseconds per frame (e.g., 1/60); in other words, a single frame arrives every 16.66 milliseconds. And, at a video frame rate of 30 frames per second, the frame inter-arrival rate is 33.33 milliseconds per frame (e.g., 1/30). In the current 3GPP Release 16 standard specification however, there is only support for integer values for DRX periodicity, such as 16 milliseconds (ms), 20 ms, 32 ms, and 40 ms. The use of these integer DRX values for video traffic may cause problems. For example, supposing the DRX periodicity is equal to 32 ms for a frame inter-arrival rate of 33.33 ms per frame, the UE in this example will wake up early (i.e., 1.33 ms before a new frame arrival). This early wake up is not a power-efficient approach. Likewise, supposing the DRX periodicity is equal to 20 ms for a frame inter-arrival rate of 16.66 ms, the UE in this example will wake up late (i.e., 3.34 ms after a new frame arrival). This late wake up is also not suitable for the UE as it increases the latency for data transmission.

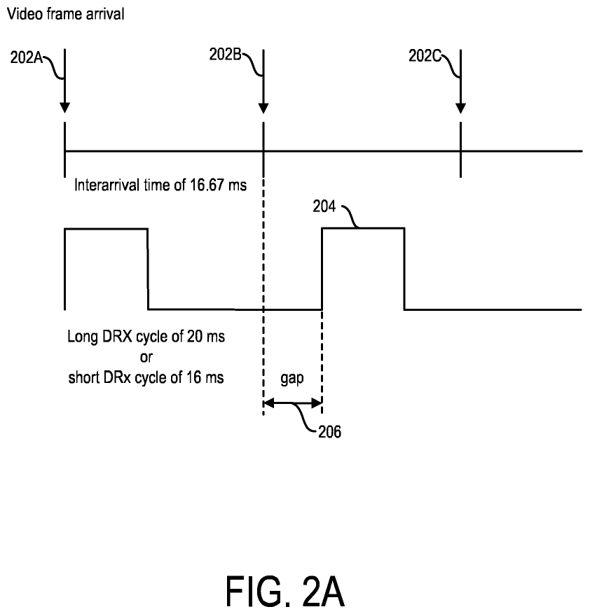

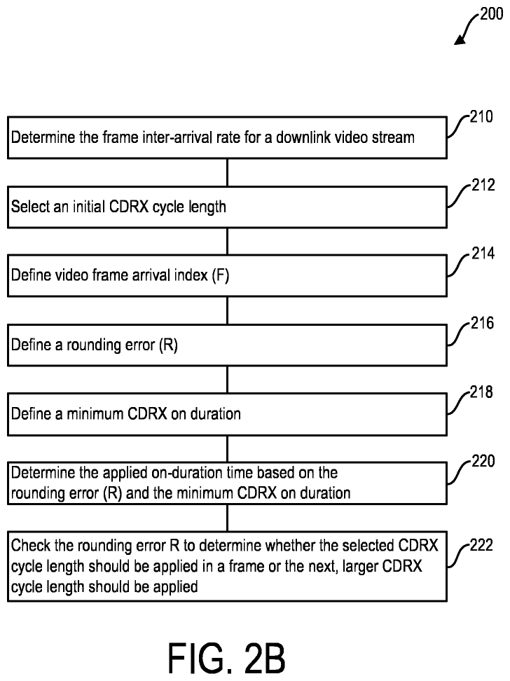

FIG. 2A depicts the arrival of video frames 202A-C having a frame inter-arrival of 16.67 ms but the UE wakes up late as shown at 204 when the DRX is 20 ms. The gap 206 is caused at least in part due to the UE waking up late. Although not shown in the example of FIG. 2A, there may be a corresponding gap between when the UE wakes up early and the arrival of a video frame. There may also be rounding errors, which may accumulate over time. The rounding errors may be caused by having a non-integer inter-arrival rate (which is 16.67 ms in this example) and rounding to an integer CDRX cycle length (which in this example is 16 ms). This rounding error may accumulate over time as each frame is processed and may cause the UE to wake up earlier (or later) than needed to receive an arriving video at a given frame. FIG. 2A illustrates by way of an example a need to adjust the DRX cycle over time to compensate for these rounding errors and to better match the DRX cycle rate to the traffic arrival rate (e/g/. video frame rates or the inter-frame arrival rates). Although some of the examples refer to the phrase “CDRX cycle length” or the “DRX cycle length,” these two phrases both refer to the cycle lengths used for DRX.

In some example embodiments, there may be provided an adjustment of the CDRX cycle length including the on-duration period. The adjustment of the CDRX cycle length may be dynamic, in the sense that the adjustment may be based on the downlink (DL) video frame inter-arrival rate which may change over time from frame to frame. The process for the dynamic adjustment may be applied at the network and the UE. For example, the dynamic adjustment of the CDRX cycle length may be used with RRC connected UEs, such that the CDRX settings are adjusted to provide efficient UE power savings but in an adaptive manner to ensure timely data reception of DL video traffic.

FIG. 2B depicts an example of a process for adapting the CDRX configuration, in accordance with some example embodiments.

At 210, the frame inter-arrival rate (or time) may be determined for a video stream carried on a downlink from a base station to a user equipment, in accordance with some example embodiments. For example, a node (e.g., a network node and/or a UE) may determine (e.g., obtain, calculate, or monitor) the frame rate of video being carried on a downlink to a UE. This frame rate may correspond to the frame inter-arrival rate. For example, the video's frame rate may be determined as 60 frames per second. In this example, the node may, based on the frame rate, determine that the frame inter-arrival rate is 16.66 ms per frame (which is also an inter-arrival time of 16.66 ms).

At 212, the node (e.g., a network node or a UE) may select an initial CDRX cycle length from a set of possible CDRX cycle length values (e.g., short or long DRX cycle length values), such that the selected CDRX cycle length is the largest value of the CDRX cycle length that is less than or equal to the determined frame inter-arrival rate, in accordance with some example embodiments. For example, if the inter-arrival rate is determined as 16.66 ms and the set of possible CDRX cycles includes 2 ms, 3 ms, 4 ms, . . . 16 ms, 20 ms, 32 ms, 40 ms and other integer cycle length values, the node may select 16 ms as it is the largest CDRX cycle length (which is in the set of possible cycle length values) that is less than or equal to (and thus does not exceed) the 16.66 ms frame inter-arrival rate. The set of possible cycle lengths refers to a set of predefined cycle lengths, which can be used as a cycle length in a DRX operation (see, e.g., the cycle length (or time) depicted at 102). These predefined cycle lengths may be pre-defined in a standard or other specification. And, as noted, the predefined cycle lengths may correspond to integer values of cycle lengths, such as 2 ms, 3, ms, and so forth as noted herein.

At 214, a video frame arrival index may be defined, in accordance with some example embodiments. For example, the node (e.g., a network node and/or a UE) may determine the video frame arrival index F as a function of a video frame number and a frame inter-arrival rate or time. To illustrate further, the video frame arrival index F may be determined in accordance with the following:

$$F = ( video frame number - 1 ) * frame inter - arrival rate , \qquad Eq . ( 1 )$$

wherein “*” represents a multiplication operation, and the video frame number is an indicator of a frame number in the sequence of DL video frames being processed.

At 216, a rounding error R may be defined, in accordance with some example embodiments. For example, the rounding error R may be determined based on a given frame (or frame index determined at equation 1) and a selected CDRX cycle length (e.g., as selected at 212). To illustrate further, the rounding error R may be determined in accordance with the following:

$$R = F - ( ( video frame number - 1 ) * selected CDRX cycle length ) ) , \qquad Eq . ( 2 )$$

wherein F is determined by equation 1 and the selected CDRX cycle length is the length selected at 212.

At 218, a minimum CDRX on duration (e.g., “min CDRX.OnDuration”) may be defined, in accordance with some example embodiments. In some example embodiments, the minimum CDRX on duration may be a time (which may correspond to a timer or timer value) that is defined at the network, such as a gNB, in which case the network provides the minimum CDRX on duration to the UE to allow the UE to determine an applied on duration at 220. The minimum CDRX on duration may correspond to a minimum on time needed during the DRX cycle to allow each video frame to be received and decoded by the UE. In some example embodiments, a gNB (or other node in the network) may determine a value for the min CDRX.OnDuration parameter based on one or more factors such as video frame processing and decoding delay, and the like. In some example embodiments, if the network does not provide the minimum CDRX on duration, the UE may apply a default or other available on-duration value.

At 220, the applied on-duration time for a DRX cycle (applied CDRX on-duration time) may be determined based on the rounding error (R) and the minimum CDRX on duration (e.g., “min CDRX.OnDuration”), in accordance with some example embodiments. For example, a node (e.g., the network node and/or UE) may obtain the rounding error R determined at 216 and the minimum CDRX on duration defined at 218. And, based on these values, the node may determine an applied on duration for the CDRX cycle. For a given frame for example, the applied on-duration time 104 of DRX cycle 102 may be determined based on the rounding error (which is determined at 216) at the given frame and the min CDRX on duration of 218. In this way, the applied on-duration time for the DRX cycle takes into account the minimum CDRX on duration time as well as rounding errors; in other words, the applied CDRX.OnDuration may be increased at a frame to take into account the rounding errors. In some embodiments, the applied CDRX.OnDuration may be determined in accordance with the following:

$$Applied CDRX . OnDuration = round ( R + min CDRX . OnDuration ) , \qquad Eq . ( 3 )$$

wherein applied CDRX.OnDuration is the on-duration applied at a given CDRX cycle, and the round operation represents a rounding to a next higher integer. Table 2 below depicts the applied CDRX. On duration for the frames. As can be seen by Table 2, the CDRX. On duration varies over time due in part to the change in rounding error across the frames (or frame index values).

At 222, a check is of the rounding errors is performed to determine whether the selected CDRX cycle length should be applied in a frame or the next, larger CDRX cycle length in the set of cycle length values should be applied, in accordance with some example embodiments. For example, the rounding error R may be checked to determine whether the rounding error R (216) equals or exceeds a threshold amount, in which case another CDRX cycle length should be selected from among the set of possible plus CDRX cycle length values. For example, if the rounding error equals or exceeds the threshold amount, the condition R+ selected CDRX cycle length being greater than or equal to the CDRX cycle length is not satisfied unless another cycle length (e.g., the next larger cycle length) is selected from the set of possible cycle lengths (e.g., the set of 2 ms, 3 ms, 4 ms, . . . 16 ms, 20 ms, 32 ms, 40 ms and so forth). In some example embodiments, the threshold amount (or value) corresponds to the difference between the selected CDRX cycle length and the next, larger cycle length. Given the selected cycle length of 16 ms (for example, the threshold amount is 4 ms (e.g., 20-16).

The following provides an illustrative example for purposes of explanation of the process 200 of FIG. 2B. In the following example, a downlink frame inter-arrival time is used that is equal to 16.66 ms and a minimum on duration (min CDRX.OnDuration) of 2 ms is used as well, although these values are for purposes of illustration as other inter-arrival times/rates and on durations may be used as well. In this example, a node (e.g., the network node and/or a UE) may monitor the video frames and determine, at 210, the frame rate of the video as 60 frames/sec, which corresponds to a rate of 16.66 ms per frame or an inter-arrival time of 16.66 ms. The node selects, at 212, an initial CDRX cycle length from the set of possible CDRX cycle lengths, such that the selected CDRX cycle length is the largest integer valued cycle length (in the set of possible CDRX cycle lengths) that is less than or equal to the frame inter-arrival rate. In this example, the selected CDRX cycle length is 16 ms (which is the largest cycle length in the set of possible cycle lengths less than the 16.66 ms inter-arrival time). The frame arrival index F may be defined at 214 based on equation 1 above. For example, F is equal to the (video frame number −1) multiplied by the inter-frame rate, so in this example F equals 16.7 (e.g., (2−1) multiplied by 16.7).

At 216, the rounding error R may be determined based on equation 2 above. Given for example F equal to 16.7, a frame number equal to 2, and the selected CDRX cycle equal to 16, the rounding error is 0.7 (e.g., 0.7=16.7−((2−1)*16)). Table 2 below depicts this example below as well as the rounding errors at other frames. In the example of Table 2, the minimum on duration is set to 2 ms at 218.

At 220, the applied on-duration is determined based on the rounding error (R) and the minimum on duration (min CDRX.OnDuration), in accordance with some example embodiments. For frame number 2 for example as depicted below at Table 2, the applied CDRX. On duration is 3 ms (e.g., round (0.7+2)). This applied CDRX. On duration is the on-duration time actually used at a CDRX cycle being used to receive frame 2 (see also frame arrival index 16.7) of the video traffic.

Referring again to FIG. 1, the applied CDRX on-duration would correspond to the on-duration time at 104. As shown in Table 2 below, the applied CDRX. On duration time varies over time as it takes into account the frame number (see, e.g., equation 3 above), so the applied CDRX.On duration time varies from 2 ms to 6 ms from frame 1-7. Table 2 also shows the corresponding increase in rounding error from 0-4 from frames 1-7.

At 222, a check of the rounding errors may be performed to determine whether the selected CDRX cycle length should be applied in a frame or the next, larger CDRX cycle length in the set of cycle lengths should be applied, in accordance with some example embodiments. For example, if the rounding error R (216) equal or exceeds a threshold amount, another CDRX cycle length should be selected from among the set of possible plus CDRX cycle length values. Given the selected cycle length of 16 ms, the threshold amount is 4 ms (e.g., difference between 16 and the next larger cycle length 20).

Referring again to Table 2, the set of possible CDRX cycles includes 16 ms, 20 ms, 32 ms, 40 ms and so forth, the selected cycle length is 16 ms, and the R plus the selected CDRX cycle length is 16.7 (0.7+16) at frame 2. For frame 3, R plus the selected CDRX cycle length is 17.3 (1.3+16), for frame 4 the R plus the selected CDRX cycle length is 18 (2+16), for frame 5 the R plus the selected CDRX cycle length is 18.7 (2.7+16), for frame 6 the R plus the selected CDRX cycle length is 19.7 (2.3+16). Up until frame 6, the rounding error R plus the selected CDRX cycle length (which in this example is 16 ms selected at 212) still provides a suitable CDRX cycle length given the rounding error R. However, at frame 7, the rounding error R is 4 ms, so the rounding error equals or exceeds the threshold amount of 4 ms. As such, the selected CDRX cycle length of 16 ms should not be used for frame 7, but instead the next larger CDRX cycle length 20 ms should be used for frame 7. In other words, the check at 222 determines for a given frame whether the rounding error equals or exceeds a threshold value (e.g., wherein the threshold value is the difference between the selected CDRX value and the next, higher CDRX value in the set of possible CDRX values). At frame 8, the rounding error is below the threshold of 4 in this example, so the selected CDRX cycle of 16 ms can again be used.

TABLE 2
Example values for a frame inter-arrival rate equal
to 16.666 ms and min CDRX.OnDuration equal to 2 ms.

| Frame | | | Selected | | |
|---|---|---|---|---|---|
| Inter- | | Frame | CDRX | Applied | Rounding |
| arrival | Frame | arrival | cycle | CDRX On | error |
| Rate | number | index | length | duration | (R) |
| 16.7 | 1.0 | 0.0 | 16.0 | 2.0 | 0.0 |
| 16.7 | 2.0 | 16.7 | 16.0 | 3.0 | 0.7 |
| 16.7 | 3.0 | 33.3 | 16.0 | 3.0 | 1.3 |
| 16.7 | 4.0 | 50.0 | 16.0 | 4.0 | 2.0 |
| 16.7 | 5.0 | 66.7 | 16.0 | 5.0 | 2.7 |
| 16.7 | 6.0 | 83.3 | 16.0 | 5.0 | 3.3 |
| 16.7 | 7.0 | 100.0 | 20.0 | 6.0 | 4.0 |
| 16.7 | 8.0 | 116.7 | 16.0 | 3.0 | 0.7 |
| 16.7 | 9.0 | 133.3 | 16.0 | 3.0 | 1.3 |
| 16.7 | 10.0 | 150.0 | 16.0 | 4.0 | 2.0 |
| 16.7 | 11.0 | 166.7 | 16.0 | 5.0 | 2.7 |
| 16.7 | 12.0 | 183.3 | 16.0 | 5.0 | 3.3 |
| 16.7 | 13.0 | 200.0 | 20.0 | 6.0 | 4.0 |
| 16.7 | 14.0 | 216.7 | 16.0 | 3.0 | 0.7 |
| 16.7 | 15.0 | 233.3 | 16.0 | 3.0 | 1.3 |
| 16.7 | 16.0 | 250.0 | 16.0 | 4.0 | 2.0 |
| 16.7 | 17.0 | 266.7 | 16.0 | 5.0 | 2.7 |
| 16.7 | 18.0 | 283.3 | 16.0 | 5.0 | 3.3 |

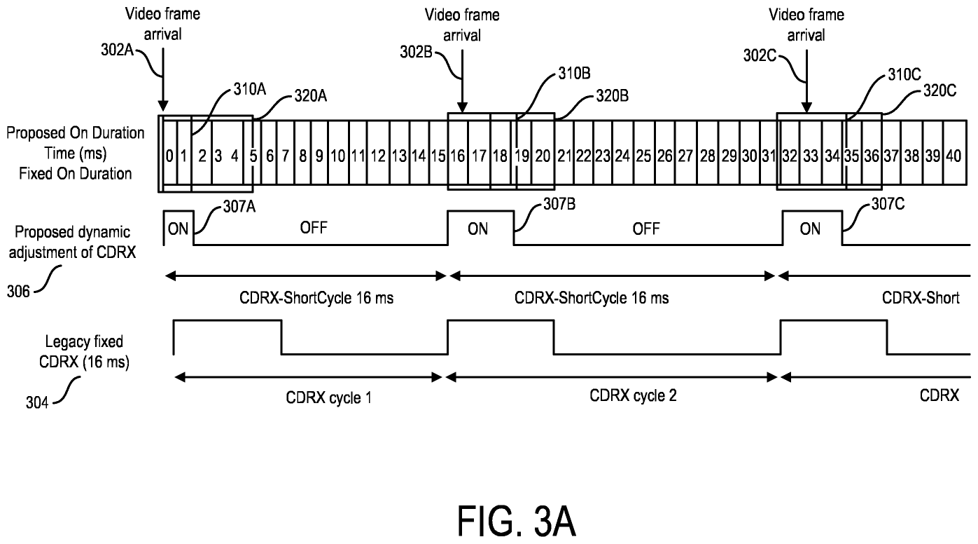

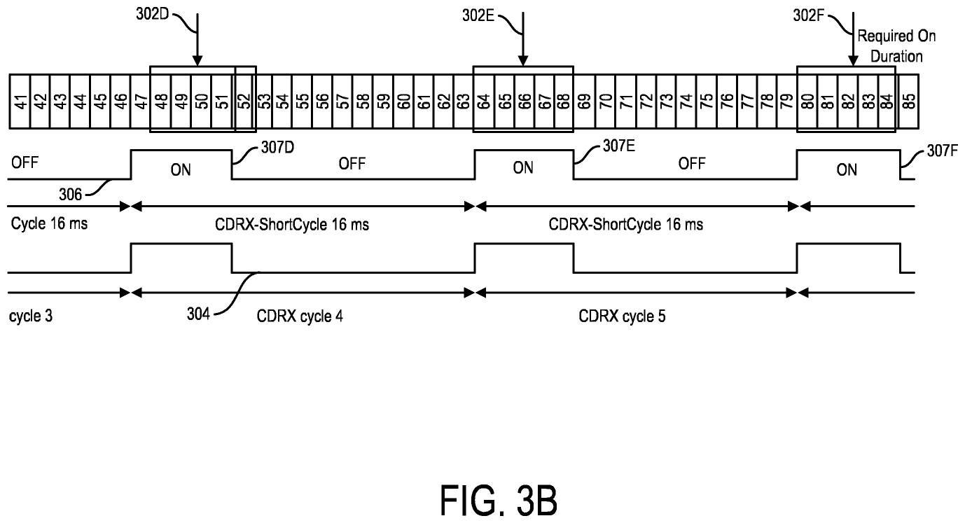

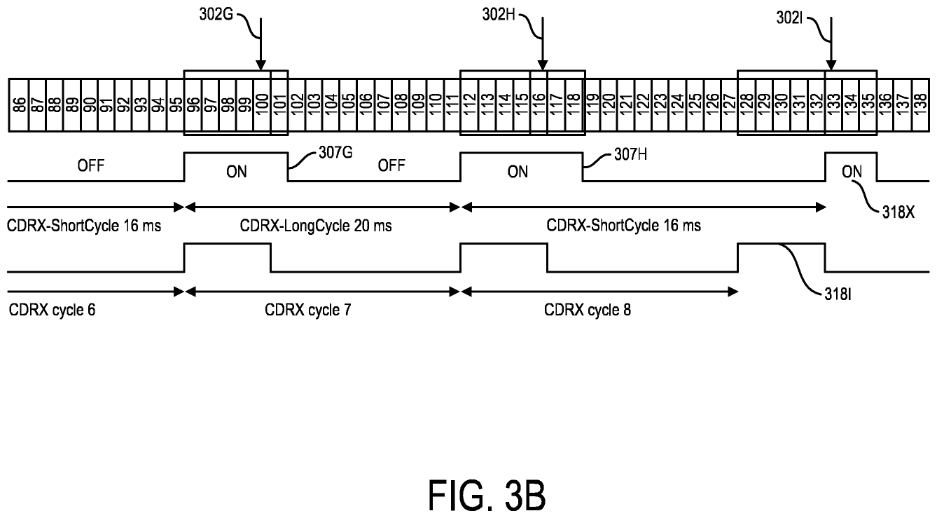

FIG. 3A-3B depict a dynamically adjusted CDRX configuration, in accordance with some example embodiments.

Referring to FIGS. 3A-3B, the drawings show the video frame arrival at 302A-I, the legacy fixed CDRX configuration 304 with a cycle length of 16 ms and a fixed on-duration period of about 5 ms. When using the dynamically adjusted CDRX configuration 306 in accordance with some example embodiments, the video frame arrival 302A-I matches with the CDRX ON duration times 307A-I. As shown, the UE wakes up 307A-C in time for the DL video frame reception and remains awake after each frame reception for a sufficient time (shown with the boxes 310A-C) to process the video frames (which are 2 ms in this example). When using the legacy fixed CDRX configuration 304 however, the rounding error will propagate leading to a total mismatch between video frame arrival and the ON duration period as shown at 3021 where the fixed legacy CDRX configuration provides an on time 3181 that misses the arrival of the stream at 3021, while the dynamically adjusted CDRX configuration properly covers at 318X the arrival. Moreover, at frame number 18 (Table 1) the adjusted CDRX configuration has a lower rounding error of 3.3, when compared to a legacy fixed CDRX configuration which has a rounding error of about 11.3 ms.

To illustrate further, the dynamically adjusted CDRX configuration may be applied using other frame inter-arrival rates/times. Table 3 below provides an example of the input and output parameters for a frame inter-arrival rate equal to 33.33 ms, for example.

TABLE 3
Solution example for frame inter-arrival rate =
33.333 ms and min CDRX.OnDuration = 2 ms.

| Frame | | | | | |
|---|---|---|---|---|---|
| Inter- | | Frame | Selected | Applied | |
| arrival | Frame | arrival | CDRX | CDRX On | Rounding |
| Rate | number | index | cycle | duration | error |
| 33.3 | 1.0 | 0.0 | 32.0 | 2.0 | 0.0 |
| 33.3 | 2.0 | 33.3 | 32.0 | 3.0 | 1.3 |
| 33.3 | 3.0 | 66.7 | 32.0 | 5.0 | 2.7 |
| 33.3 | 4.0 | 100.0 | 35.0 | 6.0 | 4.0 |
| 33.3 | 5.0 | 133.3 | 32.0 | 4.0 | 2.3 |
| 33.3 | 6.0 | 166.7 | 35.0 | 6.0 | 3.7 |
| 33.3 | 7.0 | 200.0 | 32.0 | 4.0 | 2.0 |
| 33.3 | 8.0 | 233.3 | 35.0 | 5.0 | 3.3 |
| 33.3 | 9.0 | 266.7 | 32.0 | 4.0 | 1.7 |
| 33.3 | 10.0 | 300.0 | 35.0 | 5.0 | 3.0 |
| 33.3 | 11.0 | 333.3 | 32.0 | 3.0 | 1.3 |
| 33.3 | 12.0 | 366.7 | 32.0 | 5.0 | 2.7 |
| 33.3 | 13.0 | 400.0 | 35.0 | 6.0 | 4.0 |
| 33.3 | 14.0 | 433.3 | 32.0 | 4.0 | 2.3 |
| 33.3 | 15.0 | 466.7 | 35.0 | 6.0 | 3.7 |
| 33.3 | 16.0 | 500.0 | 32.0 | 4.0 | 2.0 |
| 33.3 | 17.0 | 533.3 | 35.0 | 5.0 | 3.3 |
| 33.3 | 18.0 | 566.7 | 32.0 | 4.0 | 1.7 |

In some example embodiments, given a frame inter-arrival rate (or time) and a minimum on duration for the CDRX, the selected CDRX cycle length applied at each frame and the rounding error values (at Tables 2 and 3 for example) may be calculated in advance.

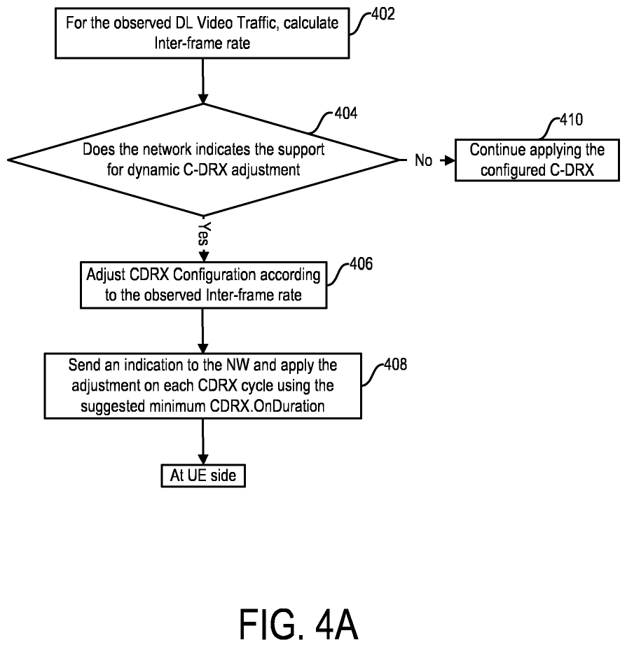

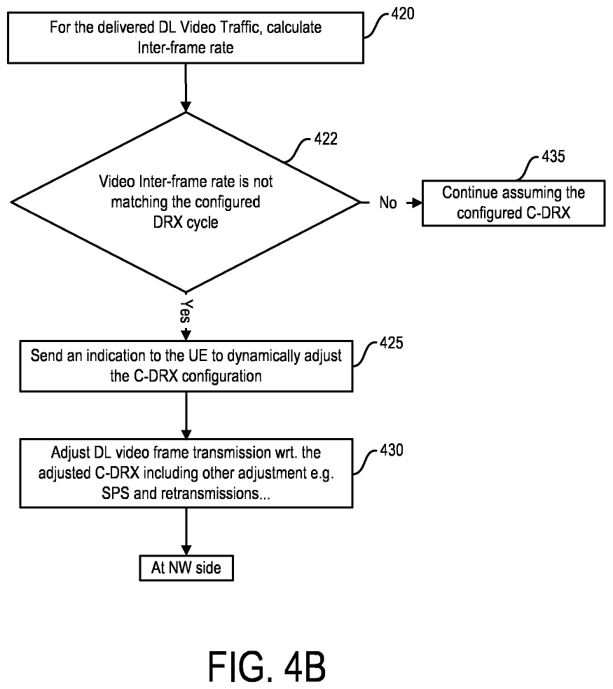

FIG. 4A depicts an example of a process for a dynamically adjusted CDRX configuration from the perspective of user equipment (UE), in accordance with some example embodiments.

At 402, the UE may observe the video frame rate of received video carried on a downlink, wherein the video frame rate is used to determine a frame inter-arrival rate or time, in accordance with some example embodiments. As noted in the example above, if it is determined that the video frame rate is 60 frames per second, the frame inter-arrival rate is 16.66 milliseconds per frame (or an inter-arrival time of 16.66 ms), and a video frame rate of 30 frames per second corresponds to 33.33 milliseconds, although other frame rates and frame inter-arrival times may be used in the video stream as well. In some example embodiments, the video frame inter-arrival rate may be calculated by the network and provided to the UE.

At 404, the UE may determine whether the network supports dynamically adjusted CDRX configuration, in accordance with some example embodiments. For example, the UE may query the network or be told by the network whether the network supports the dynamically adjusted CDRX configuration using, for example, the process 200 to dynamically adjust the CDRX cycle time and on-duration. The adjustment is dynamic in the sense that it varies over time as the frame rate of the video stream changes and/or the rounding error varies.

If the network does not support dynamically adjusted CDRX configuration (404 and no), the UE may continue, at 410, to apply the fixed CDRX configuration provided by the network.

If the network does support dynamically adjusted CDRX configuration (404 and yes), the UE may adjust, at 406, the CDRX configuration according to the observed inter-arrival frame rate. The adjustment may adjust the default CDRX cycle configuration based on the frame rate (or inter-arrival time) of the video carried on the downlink, the minimum on-duration, a selected cycle length (e.g., selected CDRX cycle length) and/or rounding errors. Process 200 at FIG. 2 describes an example process for dynamically adjusting the CDRX configuration.

At 408, the UE may send an indication to the network that the UE is (or will) apply the adjusted/dynamic CDRX configuration on one or more CDRX cycles using the suggested minimum CDRX. OnDuration provided by the network. In some example embodiments, when the network receives the indication at 522, the network knows that the UE is adapting CDRX configuration for the video frames.

FIG. 4B depicts an example of a process for dynamically adjusted CDRX configuration from the perspective of the network, in accordance with some example embodiments.

At 420, a network node, such as the gNB or other node, may calculate an inter-arrival frame rate for video being delivered to the UE via a downlink, in accordance with some example embodiments. As noted in the examples above, if it is determined that the video frame rate is 60 frames per second, the frame inter-arrival rate is 16.66 milliseconds per frame (or an inter-arrival time of 16.66 ms), and a video frame rate of 30 frames per second corresponds to 33.33 milliseconds, although other frame rates and frame inter-arrival times may be used in the video stream as well.

At 422, the network node may detect that there is a non-integer video inter-frame arrival rate or a mismatch between the inter-frame arrival rate and the configured CDRX cycle. If there the network node fails to detect the non-integer video inter-frame arrival rate and/or the noted mismatch (422 and no), the network continues to assume the UE is using the fixed CDRX configuration provided to the UE.

If there is a non-integer video inter-frame arrival rate or the noted mismatch (422 and yes), the network node may send, at 425, an indication to the UE to dynamically adjust the CDRX configuration using the process 200 of FIG. 2. The UE may then dynamically adjust the CDRX configuration from its side according to the observed frame inter-arrival rate (as noted above the UE may send an indication to the network at 408 in order to avoid any eventual mismatch on the used dynamic CDRX configuration). At some point, the network may adjust, at 430, the DL video frame transmission with respect to the newly adjusted CDRX and/or other adjustments, such as Semi-Persistent Scheduling (SPS) and retransmissions. When for example, the network adapts the CDRX configuration, the network may also adjust Semi-Persistent Scheduling (SPS) and retransmissions, such that these processes will also occur when the UE wakes up (e.g., during CDRX ON duration).

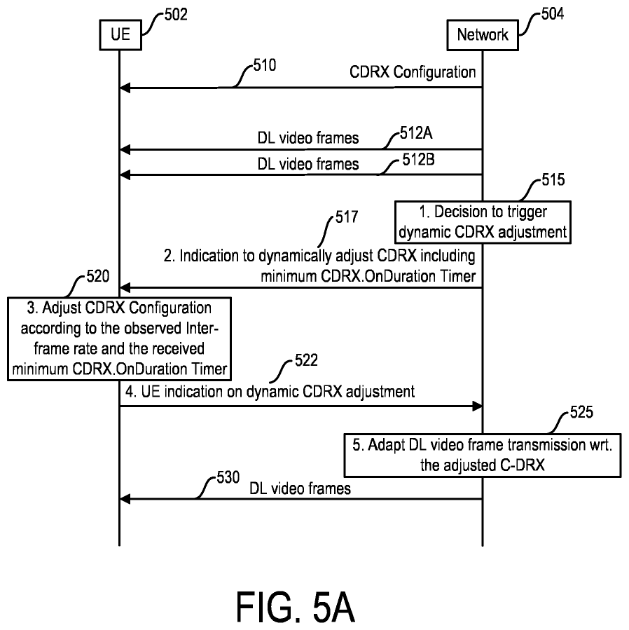

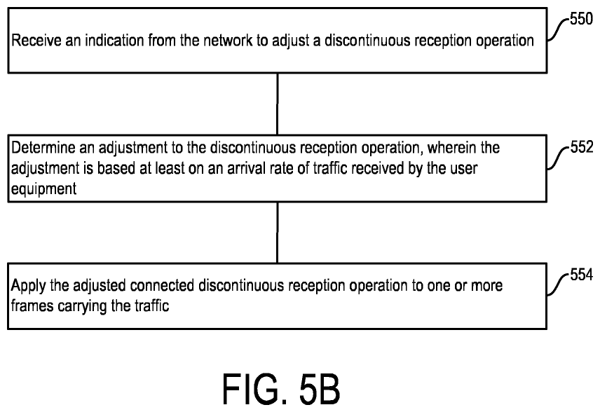

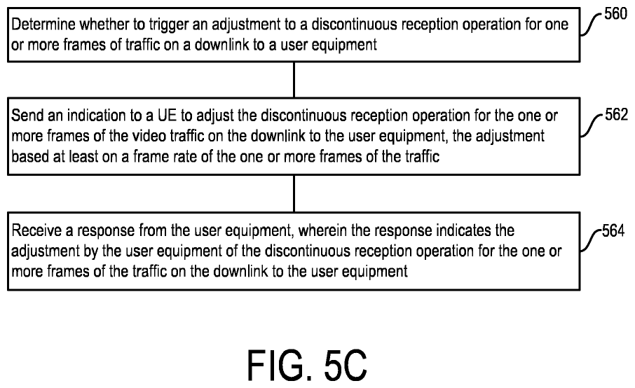

FIG. 5A depicts an example of a process between a user equipment (UE) 502 and the network 504, in accordance with some example embodiments.

At 510, the network 504 may provide a CDRX configuration to the UE 502, in accordance with some example embodiments. For example, the configuration may define the DRX operation, such as the configuration depicted at FIG. 1 with respect to cycle length and on-time. As noted, the phrase CDRX configuration and DRX configuration are used herein interchangeable to refer to the cycle lengths applied during DRX. At 512A-B, the downlink to the UE may carry video frames, in accordance with some example embodiments. When this is the case, the network may decide to trigger, at 515, the dynamic CDRX adjustment, in accordance with some example embodiments. For example, the network may trigger the dynamic CDRX adjustment in response to the downlink video frame inter-arrival time/rate not matching the configured CDRX cycle (or for example, the video frame inter-arrival time/rate not corresponding to an integer value), for example. The trigger may cause the network to send, at 517, an indication to the UE to request the UE to dynamically adjust the DRX operation to take into account the video frame inter-arrival time/rate not corresponding to an integer value. Although some of the examples refer to video traffic having the non-integer inter-arrival time/rate, other types of traffic may have non-integer arrival time/rate and may thus benefit from the dynamic adjustment processes disclosed herein. Alternatively, or additionally, this indication may include a suggested minimum CDRX.OnDuration time (or timer value). Alternatively, or additionally, the indication may inform the UE that the dynamic adjustment of the CDRX may be performed as noted above with respect to process 200 at FIG. 2, for example.

At 520, the UE may adjust the CDRX configuration based on the observed inter-arrival rate for the video frames carried in the downlink and the suggested minimum CDRX. OnDuration time (or timer value), in accordance with some example embodiments. The observed inter-arrival rate may be determined by the UE. To adjust the CDRX cycle configuration (e.g., the cycle length and on duration), the UE may perform process 200 based on the observed frame inter-arrival rate and the received minimum CDRX.OnDuration period. Tables 2 and 3 above show examples of the dynamic selection of the CDRX configuration.

At 522, the UE may send an indication to the network that dynamic adjustment of CDRX is being applied for the subsequent CDRX cycles. For example, the dynamic adjustment may begin with the start of the arrival of a frame, such as the next frame. In some example embodiments, the indication sent at 517 may be sent via downlink control information or higher-layer message (e.g. physical downlink control channel) that triggers the dynamic adjustment of the CDRX operation 520 at the UE. In some example embodiments, the UE's response (or confirmation) sent at 522 may be sent via a physical uplink control channel (PUCCH) message (e.g., a bit in the message that confirms the adjustment of the CDRX operation).

At 525, the network may adapt the DL video frame transmission with respect to the adjusted CDRX, in accordance with some example embodiments. At this point, both UE and network have matching information on how the CDRX is adjusted dynamically. The network may continue at 530 to send DL video frames according to the adjusted CDRX cycle. The network may also adjust the retransmissions (if any) and/or any other DL transmission to the UE based on the adjusted CDRX configuration. The network may further apply CDRX adjustment to configured grant (CG)/SPS configurations. As, for example, the UE's active on time is dynamically adjusted, the gNB may further provide a new CG configuration to match the UE on-periods.

In some example embodiments, the network may use information from previous sessions to predict the frame inter-arrival rate and/or to suggest a minimum CDRX.OnDuration time needed for UE to receive and process the DL video frames.

The triggering of the process 200 may be a one-time process initiated by the network for a given frame inter-arrival rate. But if the frame inter-arrival rate changes, the network may re-evaluates the process 200 and send an indication to the UE to re-adjust the dynamic CDRX setting accordingly.

FIG. 5B depicts an example of a process for adjusting the DRX configuration from the perspective of the UE, in accordance with some example embodiments.

At 550, the UE may receive an indication from the network to adjust a discontinuous reception operation, in accordance with some example embodiments. For example, the network may send an indication which indicates to the UE that the configuration of the DRX operation at the UE should be adjusted, such that the adjusted DRX operation takes into account the arrival rate of the video traffic received by the UE via a downlink. The phrase “arrival rate” refers to a frame rate of the video traffic received by the UE or an inter-arrival time of the video traffic received by the UE. The adjustment of the DRX operation may include adjusting the on-duration and/or cycle length of the DRX operation. The adjustment may be dynamic in the sense that the DRX operation may be adjusted based on at least the rounding error for a given frame and/or the frame rate (or inter-arrival time). The indication may be sent in the same or similar manner as noted above with respect to 404 and/or 517. The adjusted discontinuous reception configuration may comprise an adjustment to the DRX operation while the UE is in connected DRX.

At 552, the UE may determine an adjustment to the discontinuous reception operation, wherein the adjustment is based at least on an arrival rate of traffic received by the user equipment, in accordance with some example embodiments. For example, the traffic may be video traffic or other types of traffic with a non-integer arrival rate, such as conversation voice, realtime gamming, and/or the like. As noted above, the UE may determine an adjusted DRX operation, which may be the same or similar to the dynamic adjustment to the CDRX operation noted above with respect to 406 and/or process 200. For example, the configuration of the CDRX operation of a given frame may adjusted with respect to a selected cycle length (which is selected as noted from the set of possible CDRX cycle lengths) and/or an applied on-duration.

At 554, the UE may apply the adjusted discontinuous reception operation to one or more frames carrying the traffic, in accordance with some example embodiments. For example, when the UE has determined the adjusted DRX (or CDRX) configuration, the UE applies that to the incoming frame(s) of video as noted above at 406 and/or 520.

FIG. 5C depicts an example of a process for adjusting the DRX configuration from the perspective of the network, in accordance with some example embodiments.

At 560, the network node, such as a gNB, may determine whether to trigger an adjustment to a discontinuous reception operation for one or more frames of traffic on a downlink to a user equipment, in accordance with some example embodiments. As noted, the traffic may be video traffic or other types of traffic with a non-integer arrival rate, such as conversation voice, realtime gamming, and/or the like. For example, the network may trigger a dynamic DRX (or CDRX) adjustment in response to the downlink video frame inter-arrival time/rate not matching the configured DRX (or CDRX) cycle or the video frame inter-arrival time/rate not corresponding to an integer value as noted above with respect to 515.

At 562, the network node may send an indication to a UE to adjust the discontinuous reception operation for the one or more frames of the traffic on the downlink to the user equipment, the adjustment based at least on a frame rate of video traffic received by the user equipment, in accordance with some example embodiments. For example, the network node may, based on 560, send an indication to the UE to dynamically adjust the DRX (or CDRX operation) as noted above with respect to 517.

At 564, the network node may receive from the UE a response, in accordance with some example embodiments. This response may indicate that the adjustment by the user equipment of the discontinuous reception operation for the one or more frames of the traffic on the downlink to the user equipment. This indication may also signal to the network node to adapt the DRX operation of the traffic being transmitted towards the UE. For example, this adaptation may be in accordance with process 200, such that the network node and UE are in sync with respect to the video downlink frames being transmitted during the adjusted DRX.

Although some of the examples refer to dynamically adjusting the DRX or CDRX operation for video traffic, this dynamic adjustment may be applied to other types of traffic. For example, other types of traffic having a guaranteed bit rate and/or a fixed non-integer inter-arrival rate (which does not match the set of possible DRX cycle lengths) may also be used in coinjection with the dynamic adjustment of the DRX or CDRX operation. Examples of the noted other types of traffic include one or more of the following: conversational voice, push-to-talk voice, vehicle-to-everything (V2X) messages, realtime gaming traffic, and/or the like.

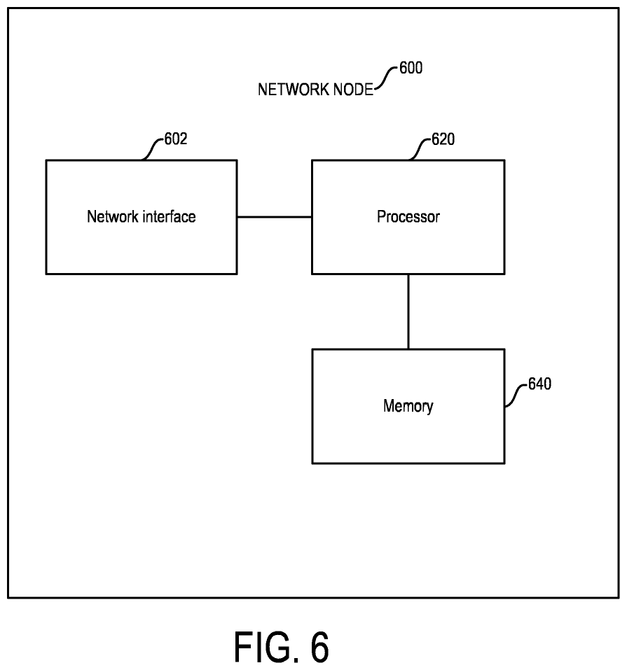

FIG. 6 depicts a block diagram of a network node 600, in accordance with some example embodiments. The network node 600 may comprise or be comprised in one or more network side nodes or functions (e.g., a gNB, an eNB, a distributed unit (DU), and/or the like).

The network node 600 may include a network interface 602, a processor 620, and a memory 604, in accordance with some example embodiments. The network interface 602 may include wired and/or wireless transceivers to enable access other nodes including base stations, other network nodes, the Internet, other networks, and/or other nodes. The memory 604 may comprise volatile and/or non-volatile memory including program code, which when executed by at least one processor 620 provides, among other things, the processes disclosed herein with respect to the network nodes. In the example embodiment, the processor network node may be configured using computer code stored in memory to the provide operations disclosed herein with respect to the network node (e.g., one or more of the processes, calculations, and the like disclosed herein including the processes at FIGS. 2B, 4B, 5A, 5C, and the like).

In some example embodiments, the network node may include determining whether to trigger an adjustment to a discontinuous reception operation for one or more frames of traffic on a downlink to a user equipment; sending an indication to adjust the discontinuous reception operation for the one or more frames of the traffic on the downlink to the user equipment, the adjustment based at least on a frame rate of the one or more frames of the traffic; and receiving a response from the user equipment, wherein the response indicates the adjustment by the user equipment of the discontinuous reception operation for the one or more frames of the traffic on the downlink to the user equipment. The adjustment may include adjusting at least one cycle length applied to the one or more frames and/or at least one on-duration time applied to the one or more frames. The determining to trigger the adjustment may be based at least on a frame inter-arrival time of the one or more frames of the traffic not corresponding to an integer value of at least one of a set of possible cycle lengths. The discontinuous reception operation may include a connected discontinuous reception operation, and/or wherein the network node may include a gNB base station and/or a distributed unit of a gNB. The sending may include sending a minimum on-duration time for the discontinuous reception operation. The network node may adapt transmission of the traffic on the downlink, the adapting based at least on the adjustment of the discontinuous reception operation. The adapting may include selecting a cycle length from a set of possible cycle lengths for the discontinuous reception operation, wherein the cycle length is selected based at least on the frame rate of the traffic. The cycle length selected may be a largest value in a set of possible cycle lengths that is less than or equal to a frame inter-arrival time of the traffic. The adapting may further include determining, based at least on a rounding error of a given frame and a minimum on-duration time, an applied on-duration time for the adjusted discontinuous reception operation, wherein the adjusted discontinuous reception operation comprises the applied on-duration time and the selected cycle length. The adapting may further include checking to confirm a rounding error of a given frame does not equal or exceed a threshold amount; and in response to the rounding error being equal to or exceeding the threshold amount, selecting another, larger cycle length from among the set of possible cycle length values, and wherein the adjusted discontinuous reception operation, for the given frame, comprises applying the larger cycle length. The traffic may include traffic with a non-integer arrival time, and/or the traffic may include video traffic.

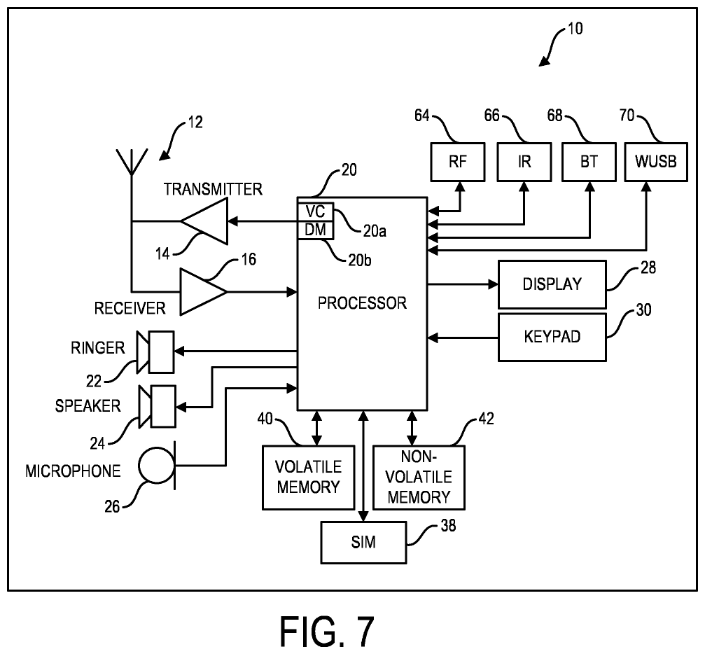

FIG. 7 illustrates a block diagram of an apparatus 10, in accordance with some example embodiments. The apparatus 10 may comprise or be comprised in a user equipment. In general, the various embodiments of the user equipment 204 can include cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions, in addition for vehicles such as autos and/or truck and aerial vehicles such as manned or unmanned aerial vehicle and as well as portable units or terminals that incorporate combinations of such functions. The user equipment may comprise or be comprised in an IoT device, an Industrial IoT (IIOT) device, and/or the like. In the case of an IoT device or ITOT device, the UE may be configured to operate with less resources (in terms of for example power, processing speed, memory, and the like) when compared to a smartphone, for example.

In some example embodiments, the apparatus 10 may receive an indication from a network to adjust a discontinuous reception operation; determine an adjustment to the discontinuous reception operation, wherein the adjustment is based at least on an arrival rate of traffic received by the user equipment; and apply the adjusted discontinuous reception operation to one or more frames carrying the traffic. The adjusted discontinuous reception operation may include adjusting at least one cycle length applied to the one or more frames and/or adjusting at least one on-duration time applied to the one or more frames. The discontinuous reception operation may include a connected mode discontinuous reception operation. The apparatus may receive a minimum on-duration time for the discontinuous reception operation. The apparatus may select a cycle length from a set of possible cycle lengths for the discontinuous reception operation, wherein the cycle length is selected based at least on the arrival rate of the traffic. The cycle length selected may be a largest value in the set that is less than or equal to the arrival rate of the traffic. The apparatus may determine, based at least on a rounding error of a given frame and a minimum on-duration time, an applied on-duration time to apply to the one or more frames carrying the traffic, wherein the adjusted discontinuous reception operation comprises the applied on-duration time and the selected cycle length. The apparatus may check to confirm a rounding error of a given frame does not equal or exceed a threshold amount; in response to the rounding error being equal to or exceeding the threshold amount, the apparatus may select another, larger cycle length from the set of possible cycle lengths, and wherein the adjusted discontinuous reception operation, for the given frame, comprises applying the larger cycle length. The threshold amount may correspond to a difference between the selected cycle length and a next, larger cycle length in the set of possible cycle lengths. The apparatus may send a response to the network, wherein the response indicates application by the user equipment of the adjusted discontinuous reception operation to the one or more frames carrying the traffic. The traffic may include traffic with a non-integer arrival time, and/or the traffic may include video traffic.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 7 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 7, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, U-SIM, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In the example embodiment, the processor 20 may be configured using computer code stored at memory 40 and/or 42 to the provide operations disclosed herein with respect to the UE (e.g., one or more of the processes, calculations, and the like disclosed herein including the processes at FIGS. 2B, 4A, 5A, 5B, and the like).

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiments, the application logic, software or an instruction set is maintained on any one of various conventional computer-readable media. In the context of this document, a “computer-readable storage medium” may be any non-transitory media that can contain, store, communicate, propagate or transport the instructions for use by or in connection with an instruction execution system, apparatus, or device, such as a computer or data processor circuitry; computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may include enhanced matching of the CDRX on duration with video frame inter-arrival rate, so the CDRX more power-efficient, reduced latency due to misalignment between interframe-rate and CDRX ON-duration, and/or reduce UE power consumption by reducing early/late CDRX wake up.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

1. A method comprising:
receiving, by a user equipment, an indication from a network to adjust a discontinuous reception operation;
determining, by the user equipment, an adjustment to the discontinuous reception operation, wherein the adjustment is based at least on an arrival rate of traffic received by the user equipment; and
applying, by the user equipment, the adjusted discontinuous reception operation to one or more frames carrying the traffic.

2-22. (canceled)

23. An apparatus comprising:
at least one processor; and
at least one memory including computer program code, the at least one memory and the computer program code configured to, with the at least one processor, cause the apparatus to at least:
receive an indication from a network to adjust a discontinuous reception operation;
determine an adjustment to the discontinuous reception operation, wherein the adjustment is based at least on an arrival rate of traffic received by the user equipment; and
apply the adjusted discontinuous reception operation to one or more frames carrying the traffic.

24. The apparatus of claim 23, wherein the adjusted discontinuous reception operation includes adjusting at least one cycle length applied to the one or more frames and/or adjusting at least one on-duration time applied to the one or more frames.

25. The apparatus of claim 23, wherein the discontinuous reception operation comprises a connected mode discontinuous reception operation.

26. The apparatus of claim 23, wherein the apparatus further receives a minimum on-duration time for the discontinuous reception operation.

27. The apparatus of claim 23, wherein the determination of the adjustment further includes selecting a cycle length from a set of possible cycle lengths for the discontinuous reception operation, wherein the cycle length is selected based at least on the arrival rate of the traffic.

28. The apparatus of claim 27, wherein the cycle length selected is a largest value in the set that is less than or equal to the arrival rate of the traffic.

29. The apparatus of claim 27, wherein the determination of the adjustment further includes determining, based at least on a rounding error of a given frame and a minimum on-duration time, an applied on-duration time to apply to the one or more frames carrying the traffic, wherein the adjusted discontinuous reception operation comprises the applied on-duration time and the selected cycle length.

30. The apparatus of claim 27, wherein the determination of the adjustment further includes checking to confirm a rounding error of a given frame does not equal or exceed a threshold amount; and in response to the rounding error being equal to or exceeding the threshold amount, selecting another, larger cycle length from the set of possible cycle lengths, and wherein the adjusted discontinuous reception operation, for the given frame, comprises applying the larger cycle length.

31. The apparatus of claim 30, wherein the threshold amount corresponds to a difference between the selected cycle length and a next, larger cycle length in the set of possible cycle lengths.

32. The apparatus of claim 23, wherein apparatus is further caused to at least send a response to the network, wherein the response indicates application by the apparatus of the adjusted discontinuous reception operation to the one or more frames carrying the traffic.

33. The apparatus of claim 23, wherein the traffic comprises traffic with a non-integer arrival time, and/or wherein the traffic comprises video traffic.

34. An apparatus comprising:
at least one processor; and
at least one memory including computer program code, the at least one memory and the computer program code configured to, with the at least one processor, cause the apparatus to at least:
determine whether to trigger an adjustment to a discontinuous reception operation for one or more frames of traffic on a downlink to a user equipment;
send an indication to adjust the discontinuous reception operation for the one or more frames of the traffic on the downlink to the user equipment, the adjustment based at least on a frame rate of the one or more frames of the traffic; and
receive a response from the user equipment, wherein the response indicates the adjustment by the user equipment of the discontinuous reception operation for the one or more frames of the traffic on the downlink to the user equipment.

35. The apparatus of claim 34, wherein the adjustment includes adjusting at least one cycle length applied to the one or more frames and/or at least one on-duration time applied to the one or more frames.

36. The apparatus of claim 34, wherein the determining to trigger the adjustment is based at least on a frame inter-arrival time of the one or more frames of the traffic not corresponding to an integer value of at least one of a set of possible cycle lengths.

37. The apparatus of claim 34, wherein the discontinuous reception operation comprises a connected discontinuous reception operation, and/or wherein the apparatus comprises a gNB base station and/or a distributed unit of a gNB.

38. The apparatus of claim 34, wherein the sending further comprises sending a minimum on-duration time for the discontinuous reception operation.

39. The apparatus of claim 34, wherein the apparatus is further caused to at least:
adapt transmission of the traffic on the downlink, the adapting based at least on the adjustment of the discontinuous reception operation.

40. The apparatus of claim 34, wherein the adapting further comprises:
selecting a cycle length from a set of possible cycle lengths for the discontinuous reception operation, wherein the cycle length is selected based at least on the frame rate of the traffic.

41-43. (canceled)

44. The apparatus of claim 34, wherein the traffic comprises traffic with a non-integer arrival time, and/or wherein the traffic comprises video traffic.

45-50. (canceled)
